(19) United States
(12) Patent Application Publication
(10) Pub. No.: US 2001/0023012 A1
(43) Pub. Date: Sep. 20, 2001

(54) COMPOSITE BODY AND METHOD OF USE

(76) Inventors: PAUL DEAR, BABRAHAM (GB); ALAN THOMAS BANKIER, SWAVESEY, CAMBRIDGE (GB); MICHAEL BRUCE PIPER, CAMBRIDGE (GB)

Correspondence Address: LEE MANN SMITH MCWILLIAMS, SWEENEY & OHLSON, PO BOX 2786, CHICAGO, IL, 606902786

(21) Appl. No.: 09/155,416

(22) PCT Filed: Mar. 14, 1997
(86) PCT No.: PCT/GB97/00709

§ 371 Date: None

(30) Foreign Application Priority Data
Mar. 29, 1996 (GB) 9606664.2

(51) Int. Cl. B32B 3/20

(52) U.S. Cl. 428/188

(57) ABSTRACT

A gel for analysis of DNA samples by electrophoresis is accommodated in the channels of a wall structure (1) formed by an extruded plastics material such as that known as Correx. For electrophoresis treatment with the plastics wall structure (1) maintained vertical in an electrophoresis tank, the sample for analysis may be added to the open top of a channel partially filled with gel (6). The wall structure (1) may have a transverse removable strip (14) giving access to the gel-filled channels, for electrophoresis with the wall structure (1) horizontal.

This invention relates to composite bodies and methods of use.

According to one aspect of the invention there is provided a composite body comprising a wall structure made from an integrally formed element having a plurality of parallel longitudinally extending channels each with an enclosed polygonal shape in transverse cross-section, the channels accommodating chemical medium or media suitable for carrying out a test, analysis or reaction procedure in situ in the channels.

The wall structure is preferably extruded from a synthetic plastics material, conveniently with the channels in a single line. The wall structure is preferably extruded with spaced parallel walls interconnected by a series of regularly spaced lateral walls to define a regular array of channels, each of square or rectangular cross-section, although other channel cross-sectional shapes (such as hexagonal) are possible, as are wall structures having more than one channel accommodated across the thickness dimension of the wall structure.

The wall structure may be extruded from any suitable synthetic plastics material having properties appropriate to the test, analysis or reaction procedure to be carried out. Polypropylene has been found to be suitable where the procedure involves electrophoresis of DNA samples inserted in the channels. Initial work has been carried out using a wall structure commercially known as Correx which has square-section channels at 2 mm centres. However, other channel spacings may be used and it is envisaged that channel spacings would be smaller than 2 mm, preferably a simple fraction (such as ¼) of the distance between the wells of a standard microtitre plate, thereby facilitating automatic loading of the channels, for example by multi-channel pipettes. The wall structure may be folded so as to divide each channel into sections prefilled with channel media.

Instead of plastics, the wall structure may be made of glass or fused silica.

The chemical medium or media may include a gel, such as agarose or polyacrylamide, rendering the composite body suitable for electrophoretic analysis of samples added to the gel. Such samples may be DNA molecules, RNA molecules, proteins or other charge-carrying molecules. The chemical medium may be uniform throughout the channels or may vary in strength or concentration in a regular or other predetermined way across the array of channels. Different media may of course be accommodated in different channels. In all cases the wall structure isolates each channel to prevent any diffusion of the medium or media from one channel to another. Also, the chemical medium may be arranged to vary, eg in concentration, along the length of each channel.

The gel may fill the channels to a level which falls short of one edge of the wall structure, so that along this edge each channel has a space, typically of a few millimeters. This renders the composite body suitable for vertical positioning, with the spaces uppermost to receive samples, one in each space, to be tested or analysed. For such vertical treatment in the form of electrophoresis, the composite body may be supported in a tank holding a liquid constituting an electrophoresis buffer.

Alternatively, a composite body according to the invention may be used in a horizontal position by removing a strip from one of the planar walls, revealing access sites for the addition of the samples to be tested or analysed.

Instead of being a gel of substantially solid form, the chemical medium may be a polymer in liquid form, free flowing or viscous.

According to another aspect of the invention there is provided a method of testing, analysing or carrying out a chemical reaction, comprising using a composite body according to said one aspect of the invention, wherein the testing, analysing or reacting takes place in situ in the channels in the presence of the medium or media.

In one preferred method, the medium is a gel and the method includes adding to each channel a sample which is analysed by electrophoresis.

The invention will now be further described, by way of example, with reference to the accompanying drawings, in which:

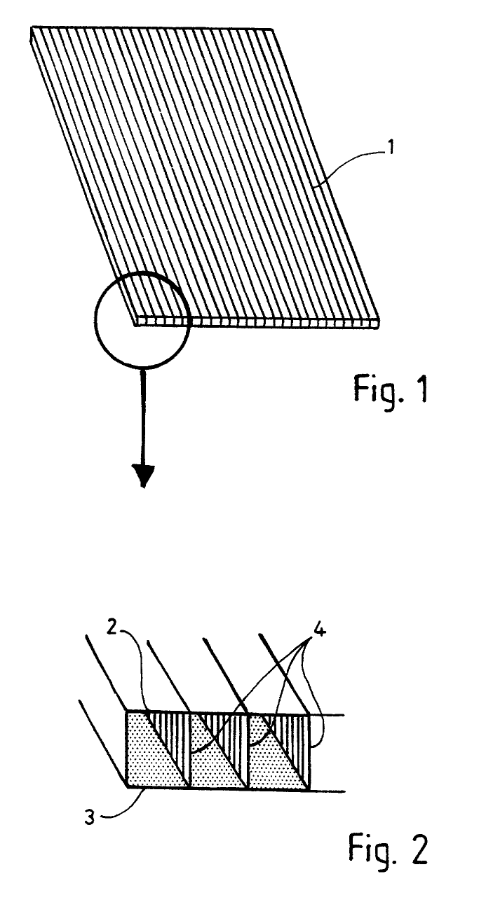

FIG. 1 is an isometric view of a wall structure of a composite body according to the invention,

FIG. 2 is a detailed view, to an enlarged scale, of the circled part of FIG. 1,

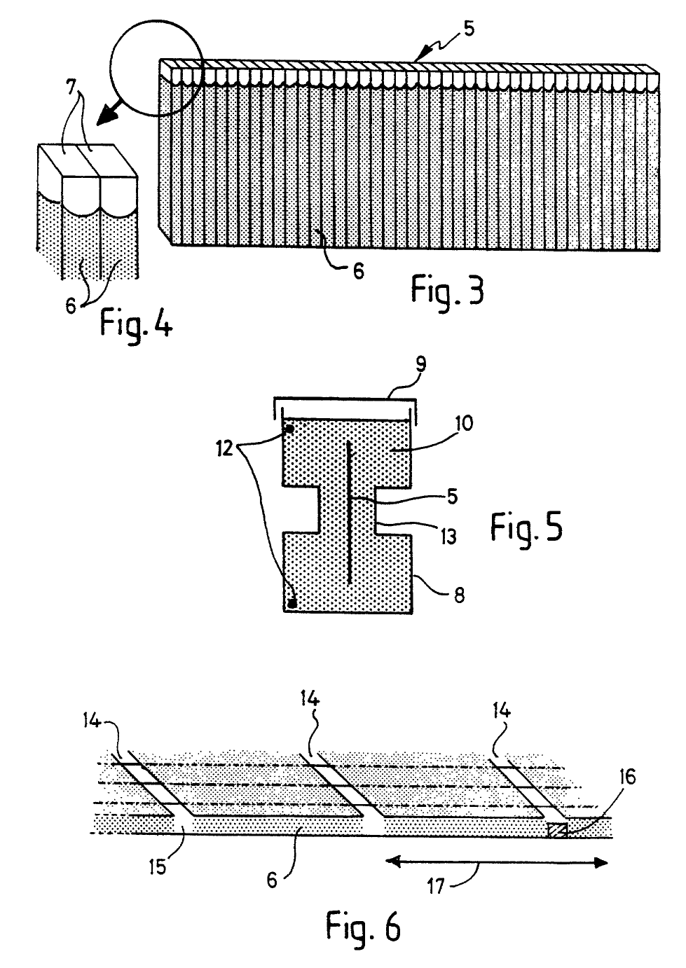

FIG. 3 is an isometric view of the composite body according to the invention,

FIG. 4 is a detailed view, to an enlarged scale, of the circled part of FIG. 3,

FIG. 5 is a diagrammatic cross-sectional view showing the composite body supported in a tank and being used in a vertical gel format,

FIG. 6 is a diagrammatic fragmentary view showing the composite body being used in a horizontal gel format,

FIGS. 7a to 7c show how a wall structure of a composite body according to the invention can be creased and folded,

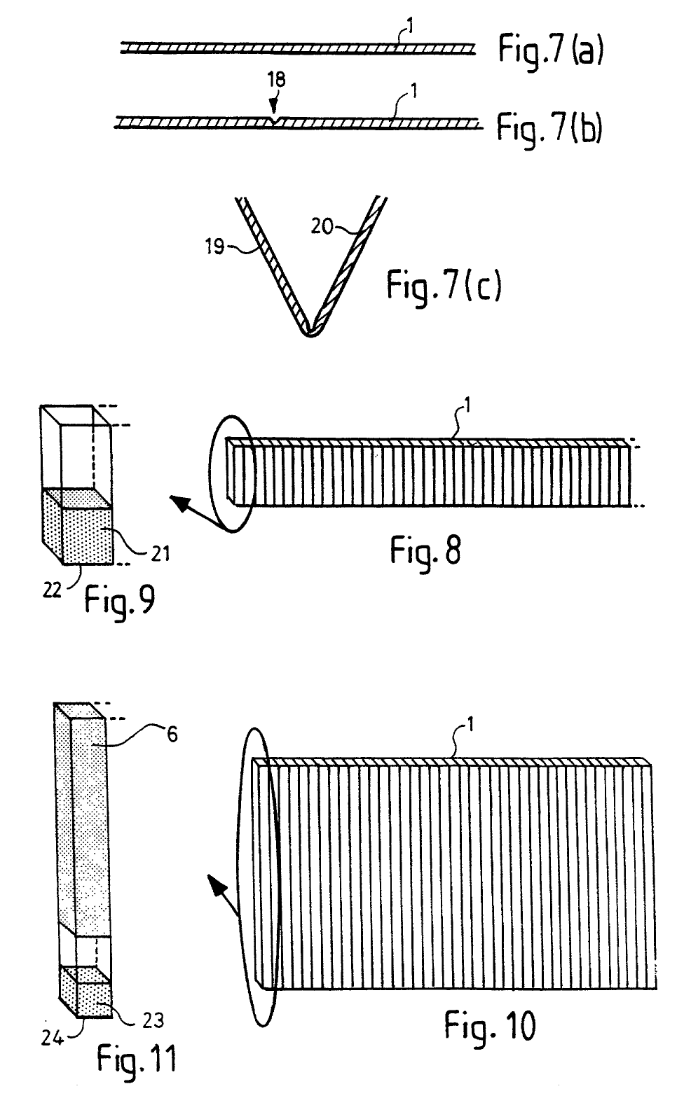

FIG. 8 illustrates the composite body being used to provide individual chambers for biochemical reactions,

FIG. 9 is a detailed view, to an enlarged scale, of the circled part of FIG. 8,

FIG. 10 illustrates the composite body being used to provide individual chambers for combined reactions and electrophoretic gel.

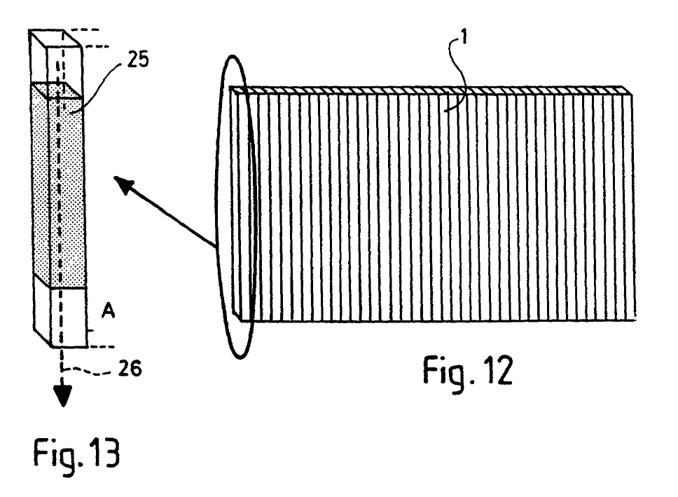

FIG. 11 is a detailed view, to an enlarged scale, of the circled part of FIG. 10,

FIG. 12 illustrates the composite body being used to provide channels for purification and analysis, and

FIG. 13 is a detailed view, to an enlarged scale, of the circled part of FIG. 12.

The wall structure 1 shown in FIGS. 1 and 2 comprises a panel of a commercially available semi-rigid packaging material known as Correx. This is extruded from polypropylene so as to have parallel walls 2, 3 (FIG. 2) interconnected by a series of regularly spaced lateral webs or walls 4, thereby defining a plurality of longitudinally extending channels each of square cross-sectional shape with an edge dimension of about 2 mm. It will be appreciated that each channel is separated or isolated from the other channels and forms, in effect, a separate chamber extending in a longitudinal direction in the wall structure.

Each channel of the wall structure is partially filled with a gel (for example agarose or polyacrylamide) in order to form the composite body 5 of FIGS. 3 and 4. Each channel is filled with gel 6 to a few millimeters of the top of the channel, leaving a space 7 at the top of each channel. Such a composite body 5 can be wrapped to prevent drying out of the gel and supplied to users for analysis of DNA samples (or other samples) by electrophoresis.

Methods of filling the channels with the gel 6 (initially in a liquid form, which sets or polymerises after filling) include, but need not be limited to:

a) immersing the wall structure 1 in a trough of liquid gel to within a short distance of one edge, allowing the gel mixture to flow into each channel. After the gel becomes solid, the wall structure 1 is removed from the trough, retaining the gel in the channels.

b) Temporarily closing the bottom end of each channel and pipetting or injecting liquid gel into each channel to the chosen depth.

In either case, the upper surface of the gel 6 may be protected during setting by an overlying inert substance (eg nitrogen gas or an organic solvent), as the polymerisation of some gel compounds (eg acrylamide) is inhibited by contact with atmospheric oxygen.

A wide range of gel mixtures (including mixtures containing dyes) is possible.

The composite body 5 can now be used as a “vertical gel”. The body 5 is immersed in a suitable electrophoresis tank such that the spaces in the channels (above the gel) are immersed in a buffer liquid. DNA samples are then pipetted into each such space 7. It is also possible to pipette the samples into the spaces before the body 5 is immersed in the buffer liquid. Electrophoresis then causes the DNA to migrate down through each channel, as in a conventional vertical gel.

The samples can be visualised using a fluorescent DNA-staining dye such as ethidium bromide or SyBr green. Either the gel (and buffer) contain dye, or the samples may be pre-stained with dye. The entire composite body is simply placed directly on a U.V. transilluminator, and photographed in the conventional way. The plastic from which the wall structure is made is sufficiently transparent to both U.V. and visible light to allow this.

To date, both agarose and polyacrylamide gels have been tested. Best results were obtained with polyacrylamide, using samples pre-stained with SyBr Green. However, other gel/stain combinations also work well. The resolution of the gel is at least as good as that of conventional vertical gels, if not better.

The composite body 5 having channels accommodating gels has the following advantages.

1) The bodies 5 are easy to prepare. It is envisaged that pre-filled wall structures (ie Correx-type sheet pre-filled with agarose or acrylamide and ready to use) would be made commercially for single-use.

2) The bodies 5 offer a very high sample density. The existing material has channels about 2 mm wide. Hence, a strip about 20 cm wide can carry around 100 samples. Higher densities are possible.

3) The bodies are easy to handle. The material of the wall structure is semi-rigid and robust.

4) The bodies are easy to load. Each sample “well” is the open end of a rigid channel.

5) Sample loading is easily automated. The regular, rigid nature of the gels means that robotic systems can easily “find” the sample wells to load the samples.

6) The samples run straight. Each sample is confined to its own channel, and cannot “wander” sideways as in conventional vertical or horizontal systems.

This would make automated image-analysis and interpretation very much easier.

Vertical gel electrophoresis using the composite body of FIGS. 3 and 4 may be carried out in the electrophoresis tank shown diagrammatically in FIG. 5. The tank has a container portion 8 covered by a removable lid 9. The portion 8 has at each end lugs (not shown) which support and locate the composite body 5 in a vertical position, as illustrated. The tank provides a single buffer chamber filled with a buffer solution 10. A sample (eg a DNA sample) is pipetted into the space at the top of each channel. A D.C. voltage is applied across spaced upper and lower terminals 12 and electrophoresis is performed. Electrophoresis may alternatively be performed with an A.C. voltage, generally with either a longer time or a higher voltage in one direction than in the other. The tank has a reduced width middle section 13 in order to increase current density in this region. The advantages of such a vertical gel system are:

a) the body 5 can simply be “dropped in”; conventional vertical gel formats require the gel to be clamped securely against an upper buffer chamber.

b) the body 5 can be removed, examined and replaced in the tank at intermediate points during the run In a conventional format, the top buffer chamber would have to be drained and refilled to do this. Moreover. conventional glass plates do not allow visualisation of most fluorescent samples without first removing one plate (irreversibly), as glass is opaque to ultraviolet light.

c) cooling of the body 5 is efficient: it is surrounded by buffer, and the thin walls of the plastic material of the wall structure allow better heat dissipation than glass plates. Forced recirculation of the buffer could be performed (this would be difficult in a conventional vertical format in which the top and bottom buffer chambers are discrete).

d) the tank can accommodate several bodies 5 side-by-side; gaps need to be left between them to allow buffer to dissipate heat. It may be desirable to have removable blanking plates which would sit in the constricted part of the tank, to reduce the electric current passing around the bodies 5 (particularly if only one body were being run in a tank capable of accommodating more).

A composite body according to the invention can be used as a “horizontal gel”, as illustrated in FIG. 6. One or more strips 14 are removed from one wall of the wall structure of the composite body. The strips 14 extend perpendicular to the channels (giving access to the channels), and gaps 15 in the gel 6 coincide with these strips. A sample may be loaded into each channel where the channel is exposed. In FIG. 6, a liquid sample 16 is shown in longitudinal section loaded into a gap 15 in the gel. The region shown between the arrows 17 comprises a simple horizontal gel format. capable of accepting one sample (loaded into the gap in the gel) per channel. Further gaps 15 and removed strips 14 in a longer gel allow several samples to be loaded at intervals along each channel. Electrophoresis is performed in a similar way to conventional horizontal gels. The composite body 5, loaded with samples, is submerged in a tray of electrophoretic buffer across which a voltage is applied, causing electrical current to flow along the direction of the channels.

The advantages of the “channelled” nature of the composite body have already been described, and apply equally to horizontal and vertical formats. The use of several “gaps” (sample loading-points) along each channel permits more samples to be analysed, provided that each sample is electrophoresed only for a short distance (ie so that it does not migrate beyond the next sample-loading point and into the next section of gel).

FIG. 7 shows how the wall structure 1 can be creased and folded to divide each channel into discrete sections. A single channel is shown in longitudinal section. FIG. 7a shows the undeformed wall structure 1. A crease is introduced, for example by pressing a sharp edge 18 (FIG. 7b) into the material of the wall structure at right-angles to the channels (the depth of the crease is exaggerated for clarity). The material of the wall structure is then folded sharply along the crease; the channel collapses at the point of the crease, dividing it into two sections 19, 20 (FIG. 7c). Unfolding the sheet returns it to the condition of FIG. 7b, thereby allowing communication between the two sections 19, 20. Several such creases and folds may be used to divide each channel into multiple compartments.

This has several applications, exemplified by (but not limited to) the following:

Channels pre-filled with a substance may thereby be sealed to prevent desiccation or loss of contents during transit, storage or use.

Certain processes require different components to be kept separate until a defined point in the procedure; this may be accomplished using the folded wall structure. For example, a channel may be divided into two portions by an intervening crease and fold. One portion may contain reagents, whilst the other contains an agent which terminates the reaction; once the reaction in the first portion is complete, the terminating agents may be added to the reaction chamber by unfolding the crease. Conversely, unfolding a crease may be used to add reagents which are necessary to initiate reactions in many channels simultaneously. A third application may be in a combined gel/reaction-vessel as illustrated in FIGS. 10 and 11: the reaction chamber may be divided from the gel-containing portion of the channel by a crease and fold which would be unfolded after the reaction is complete, allowing the reaction products to be brought into contact with the gel. This may be advantageous in cases where components of the gel might interfere with the reaction process, or vice versa.

Such creases provide a convenient means of sealing a portion of the channel which is serving as a reaction chamber at elevated temperatures (eg, in the polymerase chain reaction), from which reagents might otherwise evaporate.

It is possible to use a succession of creases and folds, each to be unfolded in turn, to perform a multi-step process requiring the sequential addition of components to a mixture. An example would be a DNA sequencing reaction which is initiated by the addition of one set of reagents, completed (“chased”) by addition of a second set, and then terminated by addition of a third. Successive creases and folds, dividing each channel into sections, could be unfolded in turn to allow reagents to be mixed. Sheets of the material could be pre-filled with reagents (and creased and folded), and sold ready to use.

A simple clip could be devised to hold the creased material in its folded shape until the crease is required to be opened.

A composite body according to the invention can be adapted to make gels with a transverse gradient: consecutive channels in the wall structure 1 would be filled with gel mixtures containing incrementally higher concentrations of the chemical (eg urea). Such gels could be made commercially and would survive storage, as each chemical concentration is contained in a single channel of the gel. Conventional gradient gels cannot be stored because the urea diffuses across the gel during storage, thereby destroying the gradient. In the inventive gradient gel, the exact concentration of the varying chemical is known in each channel (in contrast to a known continuous gradient gel, where the concentration at any point across the gel can only be estimated by interpolation).

A wall structure 1 can be used to provide individual chambers for performing biochemical reactions, as illustrated in FIGS. 8 and 9. By sealing a lower edge 22 of the structure 1, a narrow (eg 1 to 2 cm) strip of structure 1 becomes a series of individual compartments or chambers suitable for containing biochemical reactions involving reagents 21.

Advantages include a compact arrangement, easy addition of reagents (eg robotically, due to regular structure), and rapid thermal equilibration (due to thin walls of material):

The sealing of the edge 22 could be by heat-sealing, ultrasonic welding, adhesive film, or crimping (but not limited to these).

Variations include:

1) For reactions involving prolonged incubation and/or high temperatures (eg polymerase chain reaction, PCR), evaporation is a problem. This is preventable by either an overlay of mineral oil (as is often used for PCR) or by sealing the top of each channel after reagent addition (for which the sealing must be done by the user).

2) The same vessel acts as a high-density storage medium (for any liquid or suspended material—particularly bacterial cultures) if the top edge can be opened and re-sealed several times (eg by a toothed flexible strip, with the teeth fitting into the tops of the channels).

3) If the plastic of the wall structure has suitable optical properties, liquid reactions which are monitored by optical methods (eg colourimetric of fluorometric assays) can be performed and analysed in the same vessel. This would require suitably adapted colourimeters/fluorimeters.

4) An entire range of pre-loaded reagent vessels is possible. For example, a strip of composite body could be sold pre-filled with frozen or dried reagents, requiring the user to add only the remaining ingredient(s). This could be important wherever large numbers of similar reactions (eg sequencing, PCR, diagnostics) are performed.

A composite body according to the invention may provide a combined reaction vessel and electrophoretic gel, as illustrated in FIGS. 10 and 11. The body has a wall structure 1 consisting of a wide strip of the material. Most of each channel is filled with a suitable gel mixture 6 (eg polyacrylamide), leaving a space at one end. Reagents 23 are introduced into this space, and the end of the channel is sealed at 24. With the gel-filled portion uppermost, the reaction (eg polymerase chain reaction) is performed. Following reaction, the strip is inverted and the seal is removed. The reaction products are then resolved through the gel (as in the vertical electrophoresis format described previously).

The advantages are as stated: for vertical gel application and reaction-vessel application. An added benefit is the ability to perform and analyse reactions without the need to transfer the reaction products.

Many processes for analysing and purifying complex substances and mixtures are performed using devices collectively referred to as “columns”. In the conventional format, these consist of tubes which are either filled with a granular or porous agent, or coated internally with a substance. Liquid is passed through the column (either pressure-driven or under gravity), and different components in the liquid are retained in the column to varying degrees. Examples of this sort of technology include:

a) Gel filtration. The column is filled with porous particles, into which the smaller molecules of the passing liquid diffuse; they are therefore retarded in their motion through the column, relative to the main liquid flow.

b) Affinity chromatography. The porous contents of the column (or the internal coating or its walls) are chosen so as to bind selectively to certain components in the liquid passing through. These components are therefore retained, and may subsequently be eluted from the column using a different liquid.

c) Simple filtration. The contents of the column are porous, and particles or molecules in the liquid passing through are retarded on the basis of their size by a simple “sieving” process.

All of these processes accomplish some fractionation of the liquid sample, and may therefore be used for either purification or analysis. For example, the quantities of material emerging from the column may be quantified (eg by optical absorbance, fluorescence, electrical conductivity), and distinguished on the basis of the speed with which they pass through the column or the composition of the liquid which is required to elute them from the column after they have initially bound to it.

Essentially any of the “column based” approaches may be adapted so that the wall structure 1 may be used: each channel would be filled or internally coated with a suitable agent, and used as a single column. Some methods (eg those involving high-pressure liquid flow, high temperatures or certain solvents which attack the material) may not be adaptable to this material. If the optical properties of the plastic material permit, it should also be possible to perform optical monitoring of the liquid sample as it passes through the channel, as illustrated in FIGS. 12 and 13, where reference 25 denotes a porous or granular material filling the channel, or a coating on the internal surfaces of the channel, and reference 26 indicates a liquid flowing through the channel.

The wall structure 1 is cheap and easily manufactured and is therefore suited to being used once and then being disposed of.

1. A composite body comprising a wall structure made from an integrally formed element having a plurality of parallel longitudinally extending channels each with an enclosed polygonal shape in transverse cross-section, the channels accommodating chemical medium or media suitable for carrying out a test, analysis or reaction procedure in situ in the channels.

2. A composite body according to claim 1, wherein the wall structure is extruded from a synthetic plastics material.

3. A composite body according to claim 2, wherein the wall structure is extruded from polypropylene.

4. A composite body according to claim 2 or 3, wherein the wall structure is extruded with spaced parallel walls interconnected by a series of regularly spaced lateral walls to define a regular array of channels, each of square or rectangular cross-section.

5. A composite body according to claim 4, wherein the chemical medium varies in strength or concentration in a regular or other predetermined way across the array of channels.

6. A composite body according to any of the preceding claims, wherein the wall structure is folded so as to divide each channel into sections prefilled with chemical medium.

7. A composite body according to any of the preceding claims, wherein the chemical medium or media includes a gel, rendering the composite body suitable for electrophoretic analysis of samples added to the gel.

8. A composite body according to claim 7, wherein the gel fills the channels to a level which falls short of one edge of the wall structure, so that along this edge each channel has a space.

9. A method of testing, analysing or carrying out a chemical reaction, comprising using a composite body according to any of claims 1 to 8, wherein the testing, analysing or reacting takes place in situ in the channels in the presence of the medium or media.

10. A method according to claim 9, wherein the method includes adding to each channel a sample which is analysed by electrophoresis.
